(19) United States
(12) Patent Application Publication
(10) Pub. No.: US 2012/0001842 A1
(43) Pub. Date: Jan. 5, 2012

(54) DISPLAY

(76) Inventor: Joseph W. Stellbrink, Corvallis, OR (US)

(21) Appl. No.: 12/827,011

(22) Filed: Jun. 30, 2010

(51) Int. Cl. G09G 3/34; G02F 1/167

(52) U.S. Cl. 345/107; 359/296

(57) ABSTRACT

A display includes a first sub-pixel and a second sub-pixel. The first sub-pixel includes a first electrokinetic display element and a first color filter over the first electrokinetic display element. The first electrokinetic display element includes a fluid with first colorants and second colorants. The second sub-pixel is laterally directly adjacent to the first sub-pixel. The second sub-pixel includes a second electrokinetic display element and a second color filter over the second electrokinetic display element. The second electrokinetic display element includes the fluid with the first colorants and the second colorants.

### BACKGROUND

Electrokinetic display systems are electro-optical information displays that form visible images using one or more of electrophoresis, electro-convection, electrochemical interaction and/or other electrokinetic phenomena. These display systems may have a plurality of states, including a transparent (or clear) state and a colored (or dark) state. For example, electro-optical display systems that use electrophoretic phenomena to translate or move colorant particles may collect those particles at least substantially out of the viewing area of the display system in reservoir regions to create a transparent state. The colorant particles also may be spread across the viewing area of the display to create a colored state. These conventional electrokinetic displays, however, cannot be easily extended to provide full-color displays.

### BRIEF DESCRIPTION OF THE DRAWINGS

FIG. 1 illustrates a cross-sectional view of one embodiment of an electrokinetic display.

FIG. 2 illustrates a cross-sectional view of another embodiment of an electrokinetic display.

FIG. 3 is a chart illustrating one embodiment of reflectance verses wavelength for color filters of an electrokinetic display.

FIG. 4 is a chart illustrating one embodiment of reflectance verses wavelength for dual-colorants of an electrokinetic display.

FIG. 5 is a chart illustrating one embodiment of reflectance verses wavelength for dual-colorants in combination with color filters of an electrokinetic display.

### DETAILED DESCRIPTION

In the following detailed description, reference is made to the accompanying drawings which form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As used herein, the term “over” is not limited to any particular orientation and can include above, below, next to, adjacent to, and/or on. In addition, the term “over” can encompass intervening components between a first component and a second component where the first component is “over” the second component.

As used herein, the term “adjacent” is not limited to any particular orientation and can include above, below, next to, and/or on. In addition, the term “adjacent” can encompass intervening components between a first component and a second component where the first component is “adjacent” to the second component.

Embodiments provide a full-color electrokinetic display based on a sub-pixel, dual-colorant arrangement. Each pixel of the display is divided into two sub-pixels, each with a different color filter. In one embodiment, each color filter transmits approximately 50% of the visible wavelengths while absorbing the wavelengths transmitted by the other color filter. The same two colorants are used in each sub-pixel. In one embodiment, each of the two colorants modulates approximately 50% of the wavelengths transmitted by each color filter. In this way, a lower cost, more optically efficient, full-color electrokinetic display is provided compared to conventional displays.

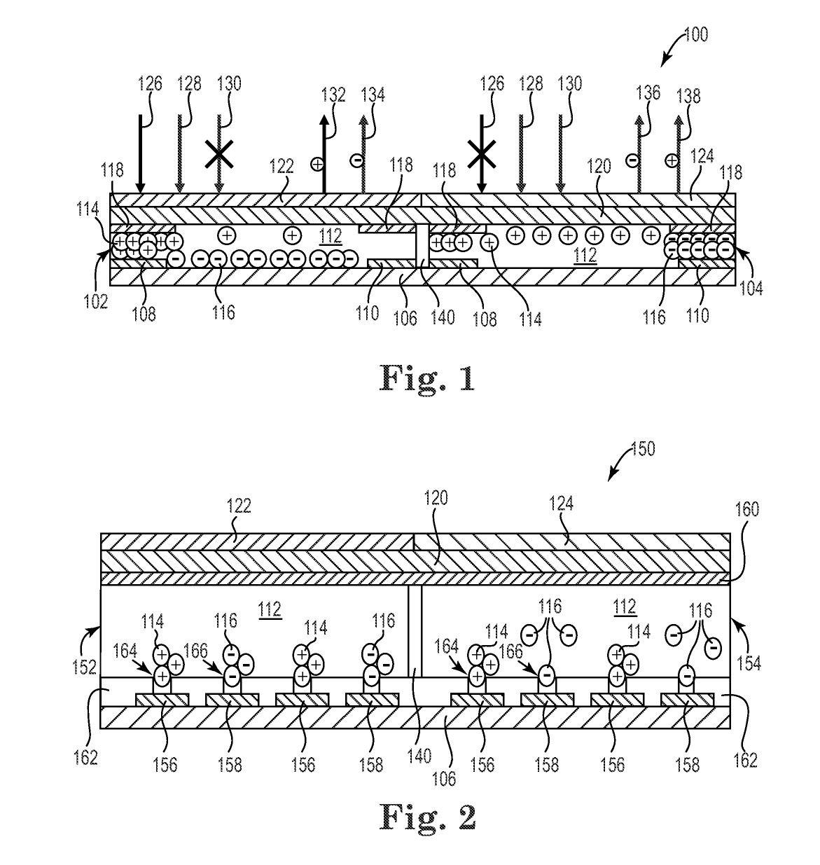

FIG. 1 illustrates a cross-sectional view of one embodiment of an electrokinetic display 100. Electrokinetic display 100 includes a first sub-pixel 102 and a second sub-pixel 104. First sub-pixel 102 and second sub-pixel 104 provide a single full-color pixel for electrokinetic display 100. While one pixel is illustrated in FIG. 1, electrokinetic display 100 may include any suitable number of pixels.

First sub-pixel 102 and second sub-pixel 104 each include a first substrate 106, a first electrode 108, a second electrode 110, a carrier fluid 112 with first colorants 114 and second colorants 116, an opaque or black mask 118, a second substrate 120, and sidewalls 140. First sub-pixel 102 includes a first color filter 122, and second sub-pixel 104 includes a second color filter 124.

First substrate 106 is parallel to and opposite second substrate 120. In one embodiment, first substrate 106 and/or second substrate 120 include an optically clear or transparent material, such as plastic (e.g., polyethylene terephthalate (PET)), glass, or other suitable material. In another embodiment, first substrate 106 is coated with or comprises a reflective material. In yet another embodiment, substrate 106 is an opaque material. In still another embodiment, a light scatterer is formed on substrate 106.

First electrode 108 and second electrode 110 of each sub-pixel 102 and 104 are formed on first substrate 106. First electrode 108 and second electrode 110 are spaced apart from each other in the same plane and arranged at opposite sides of each sub-pixel 102 and 104. First electrodes 108 and second electrode 110 may be transparent or opaque. In one embodiment, first electrode 108 and second electrode 110 are formed from a film of transparent conductive material. The transparent conductive material can include carbon nanotube layers, silver nanowire layers, metal meshes, a transparent conducting oxide such as ITO (Indium Tin Oxide), or a transparent conducting polymer such as PEDOT (poly 3,4-ethylenedioxythiophene). Other embodiments use other materials, such as metals, that provide suitable conductivity for electrokinetic display 100.

Carrier fluid 112 within each sub-pixel 102 and 104 includes either polar fluids (e.g., water) or nonpolar fluids (e.g., dodecane). In other embodiments, anisotropic fluids such as liquid crystal is used. The fluid may include surfactants such as salts, charging agents, stabilizers, and dispersants. In one embodiment, the surfactants provide a fluid that is an electrolyte that is able to sustain current by ionic mass transport. In other embodiments, the fluid may include any suitable medium for enabling fluidic motion of charged particles.

Colorants 114 and 116 in carrier fluid 112 within each sub-pixel 102 and 104 are colorant particles comprised of charged material. The colorant particle material should be able to hold a stable charge indefinitely so that repeated operation of the display does not affect the charge on the colorant particles. Colorant particle materials having a finite ability to hold a stable charge, however, can be used in accordance with the various embodiments while they maintain their charge. Colorant particles may have a size between several nanometers and several tens of microns and have the property of changing the spectral composition of the incident light by absorbing and/or scattering certain portions of the spectrum. As a result, the particles appear colored, which provides a desired optical effect. In other embodiments, the colorant can be a dye, which is comprised of single absorbing molecules.

Opaque mask 118 of each sub-pixel 102 and 104 is formed on second substrate 120. The space within each sub-pixel 102 and 104 between each portion of opaque mask 118 defines a main display volume where the displayed color of each sub-pixel can be controlled. Opaque mask 118 masks first electrode 108 and second electrode 110 so that first electrode 108 and second electrode 110 do not tint the displayed color of electrokinetic display 100. In addition, opaque mask 118 also masks colorants 114 and 116 when they are collected by first electrode 108 or second electrode 110 out of the main display volume so that the colorants do not tint the displayed color of electrokinetic display 100.

First color filter 122 and second color filter 124 are applied on second substrate 120. First color first 122 is aligned over first sub-pixel 102, and second color filter 124 is aligned over second sub-pixel 104. First color filter 122 transmits approximately one half of the visible wavelengths while absorbing the wavelengths transmitted by second color filter 124. Likewise, second color filter 124 transmits the other half of the visible wavelengths while absorbing the wavelengths transmitted by first color filter 122. In one embodiment, first color filter 122 and second color filter 124 include complementary colors such that they transmit different wavelengths of light.

The same two colorants 114 and 116 are used in each sub-pixel 102 and 104. First colorants 114 are positively charged and second colorants 116 are negatively charged. In one embodiment of first sub-pixel 102, first colorants 114 modulate approximately one half of the wavelengths of light transmitted by first color filter 122, and second colorants 116 modulate the other half of the wavelengths of light transmitted by first color filter 122. Likewise for second sub-pixel 104, first colorants 114 modulate approximately one half of the wavelengths of light transmitted by second color filter 124, and second colorants 116 modulate the other half of the wavelengths of light transmitted by second color filter 124. In one embodiment, first colorants 114 and second colorants 116 include complementary colors such that they modulate different wavelengths of light. Color filters 122 and 124 and colorants 114 and 116 may include any suitable color combinations depending upon the application.

In operation, positively charged first colorants 114 can be electrophoretically moved to first electrode 102 and held there by a negative bias applied to first electrode 102 relative to second electrode 110. Negatively charged second colorants 116 can be electrophoretically moved to second electrode 110 and held there by a positive bias applied to second electrode 110 relative to first electrode 102. By controlling the bias applied to first electrode 108 and second electrode 110, colorants 114 and 116 can be either collected out of the main display volume of each sub-pixel 102 and 104 or a controlled quantity of each colorant 114 and 116 can be spread throughout the main display volume of each sub-pixel 102 and 104.

For example, as illustrated in FIG. 1, electrodes 108 and 110 of sub-pixel 102 have been biased such that the majority of first colorants 114 have been collected adjacent to first electrode 108 out of the main display volume. Some first colorants 114, however, remain in the main display volume. The collected first colorants 114 are masked by opaque layer 118. Second colorants 116 have been spread throughout the main display volume. Electrodes 108 and 110 of sub-pixel 104 have been biased such that second colorants 116 have been collected adjacent to second electrode 110 out of the main display volume. The collected second colorants 116 are masked by opaque layer 118. First colorants 114 have been spread throughout the main display volume.

Light in the visible spectrum as indicated by arrows 126, 128, and 130 incident on electrokinetic display 100 is absorbed or reflected based on first color filter 122, second color filter 124, and the combination of first colorants 114 and second colorants 116 within the main display volume. First color filter 122 transmits some wavelengths of the visible spectrum as indicated by arrows 126 and 128 while absorbing other wavelengths as indicated by the “X” through arrow 130 of first sub-pixel 102. First sub-pixel 102 modulates the wavelengths indicated by arrow 126 by controlling the movement of first colorant particles 114 as indicated by arrow 132. First sub-pixel 102 modulates the wavelengths indicated by arrow 128 by controlling the movement of second colorant particles 116 as indicated by arrow 134.

Likewise, second color filter 124 transmits some wavelengths of the visible spectrum as indicated by arrows 128 and 130 while absorbing other wavelengths as indicated by the “X” through arrow 126 of second sub-pixel 104. Second sub-pixel 104 modulates the wavelengths indicated by arrow 128 by controlling the movement of second colorant particles 116 as indicated by arrow 136. Second sub-pixel 104 modulates the wavelengths indicated by arrow 130 by controlling the movement of first colorant particles 114 as indicated by arrow 138. In this way, the color of electrokinetic display 100 can be set by controlling the movement of colorants 114 and 116.

FIG. 2 illustrates a cross-sectional view of another embodiment of an electrokinetic display 150. Electrokinetic display 150 includes a first sub-pixel 152 and a second sub-pixel 154. First sub-pixel 152 and second sub-pixel 154 provide a single full-color pixel for electrokinetic display 150. While one pixel is illustrated in FIG. 2, electrokinetic display 150 may include any suitable number of pixels.

First sub-pixel 152 and second sub-pixel 154 each include first substrate 106, first electrode 156, second electrode 158, a dielectric layer 162 including recess regions 164 and 166, fluid 112 with first colorants 114 and second colorants 116, a third electrode 160, second substrate 120, and sidewalls 140. First sub-pixel 152 includes first color filter 122, and second sub-pixel 154 includes second color filter 124.

In this embodiment, first electrode 156 and second electrode 158 of each sub-pixel 152 and 154 are segmented electrodes formed on first substrate 106. Dielectric layer 162 is formed on first substrate 106, first electrode 156, and second electrode 158. Dielectric layer 162 is structured with recess regions 164 that allow charged first colorants 114 to compact on first electrode 156 and recess regions 166 that allow charged second colorants 116 to compact on second electrode 158.

Third electrode 160 is a blanket or plate electrode formed on second substrate 120 and is separated from first electrode 156 and second electrode 158. Third electrode 160 includes a transparent conductive material, such as carbon nanotube layers, a transparent conducting oxide such as ITO (Indium Tin Oxide), or a transparent conducting polymer such as PEDOT (poly 3,4-ethylenedioxythiophene). Third electrode 160 is used in combination with first electrode 156 and second electrode 158 to control the movement of colorants 114 and 116. In another embodiment, third electrode 160 is a segmented electrode.

In operation, positively charged first colorants 114 can be electrophoretically and convectively moved to first electrode 156 and compacted in recess regions 164 by a negative bias applied to first electrode 156 relative to third electrode 160. Negatively charged second colorants 116 can be electrophoretically and convectively moved to second electrode 158 and compacted in recess regions 166 by a positive bias applied to second electrode 158 relative to third electrode 160. In one embodiment, a reference or ground signal is applied to third electrode 160. By controlling the bias applied to first electrode 156 and second electrode 158 relative to third electrode 160, colorants 114 and 116 can be either collected out of the main display volume of each sub-pixel 152 and 154 or a controlled quantity of each colorant 114 and 116 can be spread throughout the main display volume of each sub-pixel 152 and 154. In one embodiment, pulse width and/or amplitude modulation between first electrode 156 and third electrode 160 controls the movement of first colorants 114 while pulse width and/or amplitude modulation between second electrode 158 and third electrode 160 controls the movement second colorants 116.

Light in the visible spectrum incident on electrokinetic display 150 is absorbed or reflected based on first color filter 122, second color filter 124, and the combination of first colorants 114 and second colorants 116 as previously described with reference to FIG. 1. In this way, the color of electrokinetic display 150 can be set by controlling the movement of colorants 114 and 116.

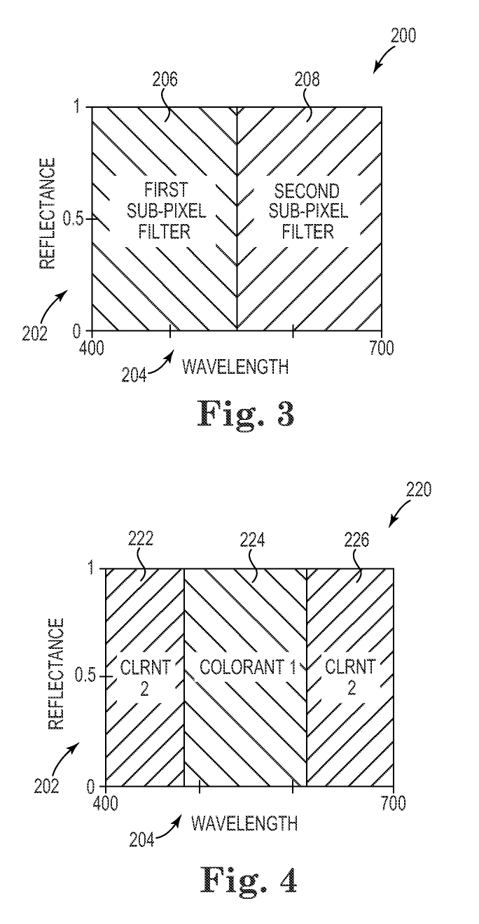

FIG. 3 is a chart 200 illustrating one embodiment of reflectance 202 verses wavelength 204 for color filters 122 and 124 of an electrokinetic display, such as electrokinetic display 100 previously described and illustrated with reference to FIG. 1 or electrokinetic display 150 previously described and illustrated with reference to FIG. 2. The reflectance axis 202 varies from 0, which indicates that none of the incident light is reflected, to 1, which indicates that all of the incident light is reflected. The wavelength axis 204 varies from 400 nm to 700 nm and designates the visible spectrum.

As indicated at 206, first color filter 122 of the first sub-pixel transmits wavelengths of light between approximately 400 nm and 550 nm and absorbs or blocks wavelengths of light between approximately 550 nm and 700 nm. As indicated at 208, second color filter 124 of the second sub-pixel transmits wavelengths of light between approximately 550 nm and 700 nm and absorbs or blocks wavelengths of light between approximately 400 nm and 550 nm. In other embodiments, first color filter 122 and second color filter 124 transmit other suitable ranges of wavelengths of light.

FIG. 4 is a chart 220 illustrating one embodiment of reflectance 202 verses wavelength 204 for first colorants 114 and second colorants 116 of an electrokinetic display, such as electrokinetic display 100 previously described and illustrated with reference to FIG. 1 or electrokinetic display 150 previously described and illustrated with reference to FIG. 2. As indicated at 224, first colorants 114 modulate wavelengths of light in the center portion of the visible spectrum between approximately 475 nm and 625 nm. As indicated at 222, second colorants 116 modulate wavelengths of light in the lower portion of the visible spectrum between approximately 400 nm and 475 nm. In addition, as indicated at 226, second colorants 116 also modulate wavelengths of light in the upper portion of the visible spectrum between approximately 625 nm and 700 nm. In other embodiments, first colorants 114 and second colorants 116 modulate other suitable ranges of wavelengths of light.

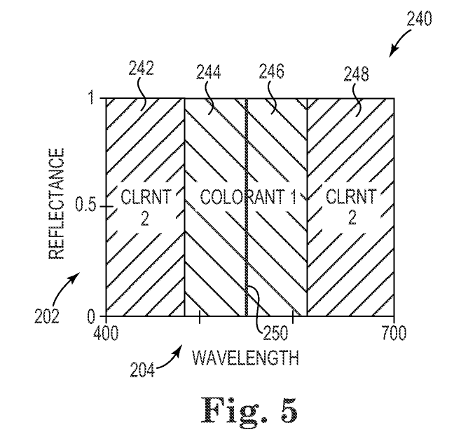

FIG. 5 is a chart 240 illustrating one embodiment of reflectance 202 verses wavelength 204 for first colorants 114 and second colorants 116 in combination with color filters 122 and 124 of an electrokinetic display, such as electrokinetic display 100 previously described and illustrated with reference to FIG. 1 or electrokinetic display 150 previously described and illustrated with reference to FIG. 2. Line 250 indicates the division of the visible spectrum between first color filter 122 and second color filter 124 as previously described and illustrated with reference to FIG. 3.

As indicated at 242, the lower portion of wavelengths of light transmitted by first color filter 122 are modulated by second colorants 116. As such, first color filter 122 and second colorants 116 control the display of about one fourth of the visible spectrum between approximately 400 nm and 475 nm. As indicated at 244, the upper portion of wavelengths of light transmitted by first color filter 122 are modulated by first colorants 114. As such, first color filter 122 and first colorants 114 control the display of about another one fourth of the visible spectrum between approximately 475 nm and 550 nm.

As indicated at 246, the lower portion of wavelengths of light transmitted by second color filter 124 are modulated by first colorants 114. As such, second color filter 124 and first colorants 114 control the display of about another one fourth of the visible spectrum between approximately 550 nm and 625 nm. As indicated at 248, the upper portion of wavelengths of light transmitted by second color filter 124 are modulated by second colorants 116. As such, second color filter 124 and second colorants 116 control the display of about another one fourth of the visible spectrum between approximately 625 nm and 700 nm. In other embodiments, color filters 122 and 124 in combination with colorants 114 and 116 control the display of other suitable ranges of wavelengths of light. In this way, a full-color electrokinetic display in which each pixel includes two sub-pixels having different color filters and the same two colorants is provided.

Embodiments provide an electrokinetic full-color display that utilizes two color filters and two colorants in a two sub-pixel configuration. The embodiments provide greater brightness, contrast, and color gamut relative to conventional electrokinetic color displays. By using the same two colorants within each sub-pixel across a single layer display, the design and manufacturing complexity of the display is greatly reduced. In addition, by using two sub-pixels instead of three or four sub-pixels as in some conventional displays, the number of addressable locations across the display is reduced by 33% to 50%, thus reducing the cost of the display electronics.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A display comprising:
a first sub-pixel comprising a first electrokinetic display element and a first color filter over the first electrokinetic display element, the first electrokinetic display element comprising a fluid with first colorants and second colorants; and
a second sub-pixel laterally directly adjacent to the first sub-pixel, the second sub-pixel comprising a second electrokinetic display element and a second color filter over the second electrokinetic display element, the second electrokinetic display element comprising the fluid with the first colorants and the second colorants.

2. The display of claim 1, wherein the first color filter and the second color filter comprise complementary colors, and
wherein the first colorants and the second colorants comprise complementary colors.

3. The display of claim 1, wherein the first color filter transmits wavelengths of light for only a lower portion of the visible spectrum, and
wherein the second color filter transmits wavelengths of light for only an upper portion of the visible spectrum.

4. The display of claim 3, wherein for the first sub-pixel, the first colorants modulate wavelengths of light for a first portion of the lower portion of the visible spectrum and the second colorants modulate wavelengths of light for a second portion of the lower portion of the visible spectrum, and
wherein for the second sub-pixel, the first colorants modulate wavelengths of light for a first portion of the upper portion of the visible spectrum and the second colorants modulate wavelengths of light for a second portion of the upper portion of the visible spectrum.

5. The display of claim 1, wherein each of the first sub-pixel and the second sub-pixel comprises:
a first substrate;
a first electrode on the first substrate;
a second electrode on the first substrate and spaced apart from the first electrode; and
a second substrate opposite the first substrate,
wherein the fluid with the first colorants and the second colorants is between the first substrate and the second substrate.

6. The display of claim 5, wherein each of the first sub-pixel and the second sub-pixel further comprises:
a black mask on the second substrate, the black mask comprising a first portion aligned with the first electrode and a second portion aligned with the second electrode.

7. The display of claim 1, wherein each of the first sub-pixel and the second sub-pixel comprises:
a first substrate;
a first electrode on the first substrate;
a second electrode on the first substrate;
a second substrate opposite the first substrate; and
a third electrode on the second substrate;
wherein the fluid with the first colorants and the second colorants is between the first substrate and the second substrate.

8. The display of claim 7, wherein the first electrode comprises a segmented electrode,
wherein the second electrode comprises a segmented electrode, and
wherein the third electrode comprises a blanket electrode.

9. A display comprising:
a plurality of pixels, each pixel consisting of a first sub-pixel and a second sub-pixel, the first sub-pixel comprising a first color filter and a fluid with first colorants and second colorants having opposite polarities, and the second sub-pixel comprising a second color filter and the fluid with the first colorants and the second colorants,
wherein the first sub-pixel and the second sub-pixel are configured to provide a full-color display.

10. The display of claim 9, wherein the first color filter transmits wavelengths of light for a lower portion of the visible spectrum and absorbs wavelengths of light for an upper portion of the visible spectrum, and
wherein the second color filter transmits wavelengths of light for the upper portion of the visible spectrum and absorbs wavelengths of light for the lower portion of the visible spectrum.

11. The display of claim 10, wherein for the first sub-pixel, the first colorants modulate wavelengths of light for a first portion of the lower portion of the visible spectrum and the second colorants modulate wavelengths of light for a second portion of the lower portion of the visible spectrum, and
wherein for the second sub-pixel, the first colorants modulate wavelengths of light for a first portion of the upper portion of the visible spectrum and the second colorants modulate wavelengths of light for a second portion of the upper portion of the visible spectrum.

12. The display of claim 9, wherein each of the first sub-pixel and the second sub-pixel comprises:
a first substrate;
a first electrode on the first substrate;
a second electrode on the first substrate and spaced apart from the first electrode; and
a transparent second substrate opposite the first substrate,
wherein the fluid with the first colorants and the second colorants is between the first substrate and the second substrate.

13. The display of claim 12, wherein each of the first sub-pixel and the second sub-pixel further comprises:
an opaque mask on the second substrate, the opaque mask comprising a first portion aligned with the first electrode and a second portion aligned with the second electrode.

14. The display of claim 12, wherein each of the first sub-pixel and the second sub-pixel comprises:
a first substrate;
a transparent first electrode on the first substrate for controlling the movement of the first colorants;
a transparent second electrode on the first substrate for controlling the movement of the second colorants;
a transparent second substrate opposite the first substrate; and
a transparent third electrode on the second substrate;
wherein the fluid with the first colorants and the second colorants is between the first substrate and the second substrate.

15. The display of claim 14, wherein the first electrode comprises a segmented electrode,
wherein the second electrode comprises a segmented electrode, and
wherein the third electrode comprises a blanket electrode.

16. A display comprising:
a first electrokinetic display element and a second electrokinetic display element, each of the first and second electrokinetic display elements comprising a fluid with first colorant particles and second colorant particles, the first colorant particles and the second colorant particles having opposite polarities;
a first color filter over the first electrokinetic display element; and
a second color filter over the second electrokinetic display element,
wherein the first color filter transmits light of first wavelengths and absorbs light of second wavelengths,
wherein the second color filter transmits light of the second wavelengths and absorbs light of the first wavelengths,
wherein the first colorant particles modulate a first portion of the first wavelengths of light and a first portion of the second wavelengths of light, and
wherein the second colorant particles modulate a second portion of the first wavelengths of light and a second portion of the second wavelengths of light.

17. The display of claim 16, wherein each of the first electrokinetic display element and the second electrokinetic display element comprise a first electrode and a second electrode to control movement of the first colorant particles and the second colorant particles, the first electrode and the second electrode laterally aligned in a plane.

18. The display of claim 16, wherein each of the first electrokinetic display element and the second electrokinetic display element comprise a first electrode, a second electrode, and a third electrode to control movement of the first colorant particles and the second colorant particles, the first electrode and the second electrode in a first plane and the third electrode in a second plane vertically spaced apart from the first plane.

19. The display of claim 16, wherein the first wavelengths of light comprise one half of the visible spectrum, and
wherein the second wavelengths of light comprise the other half of the visible spectrum.

20. The display of claim 19, wherein each of the first portion of the first wavelengths of light, the first portion of the second wavelengths of light, the second portion of the first wavelengths of light, and the second portion of the second wavelengths of light comprises one fourth of the visible spectrum.
